(19) United States
(12) Patent Application Publication
(10) Pub. No.: US 2018/0089777 A1
(43) Pub. Date: Mar. 29, 2018

(54) STAKEHOLDER LIST IDENTIFICATION

(71) Applicant: HEWLETT PACKARD ENTERPRISE DEVELOPMENT LP, Houston, TX (US)

(72) Inventors: Adi KIDRON, Tel Aviv (IL); Ilana KUPERSHMIDT, Yehud (IL); Gil NAKACHE, Yehud (IL)

(21) Appl. No.: 15/276,432

(22) Filed: Sep. 26, 2016

(51) Int. Cl. G06Q 50/18; G06N 99/00

(52) U.S. Cl. CPC G06Q 50/18; G06N 99/005

(57) ABSTRACT

Examples include stakeholder list identification. Some examples include a machine-readable storage medium with instructions executable by a processing resource of a device to identify a stakeholder list associated with a segment of an application. The machine-readable storage medium comprises instructions to receive a request to identify the stakeholder list associated with the segment of the application. The machine-readable storage medium further comprises instructions to scan an audit trail associated with the segment of the application and identify, via a machine-learning technique, the stakeholder list based on the audit trail.

### BACKGROUND

Applications may be used to perform a wide variety of tasks in computing and networking systems. In some examples, applications may be designed for mobile computing devices, whereas in other examples, applications may be designed for desktop, laptop, server, or other suitable configurations. Often, an application development project may be technically and geographically distributed and of considerable size, complexity, and scope. In some examples, effective management of or contribution to such a project involves knowledge of the owners or stakeholders of any given feature, entity, or area of the project.

### BRIEF DESCRIPTION OF THE DRAWINGS

The following detailed description references the drawings, wherein:

FIG. 1 is a block diagram of an example machine-readable storage medium having instructions executable by a processing resource to identify a stakeholder list associated with a segment of an application based on an audit trail;

FIG. 2 is a block diagram of an example machine-readable storage medium having instructions executable by a processing resource to identify a stakeholder list based on an audit trail and metadata;

FIG. 3 is a block diagram of an example machine-readable storage medium having instructions executable by a processing resource to identify a stakeholder list and identify a role of each stakeholder;

FIG. 4 is a block diagram of an example device comprising a processing resource and a machine-readable storage medium having instructions executable by the processing resource to scan an audit trail and metadata and to identify a stakeholder list based on the audit trail and the metadata;

FIG. 5 is a block diagram of an example device comprising a processing resource and a machine-readable storage medium having instructions executable by the processing resource to determine an order of each stakeholder as a function of assigned weights; and

FIG. 6 is a flowchart of an example method of identifying a stakeholder list associated with a segment of an application including receiving a request to identify the stakeholder list where the segment is a feature, entity, or area of the application and identifying the stakeholder list based on an audit trail and metadata.

### DETAILED DESCRIPTION

Applications may provide a variety of different functionalities to allow performance of a wide variety of tasks. During application development, these functionalities may be categorized as application features, application entities, or application areas. Each of feature, entity, or area of an application may have different stakeholders that manage or contribute to the feature, entity, or area. As used herein, a stakeholder may refer to an individual that is actively involved with a feature, entity, or area of an application and can influence the feature, entity, or area of the application. Some stakeholders may have a greater or lesser degree of involvement and influence than others.

Over time, the stakeholders of a particular, feature, entity, or area of the application may evolve and shift as individuals move on, move up, or change roles. In some examples, each feature, entity, or area of the application may have multiple stakeholders in various roles. For instance, in one example, a stakeholder of a particular feature may be a quality assurance technician tasked with testing the feature. In another example, a stakeholder of an entity may be a functional architect tasked with defining the entity. In yet another example, a stakeholder may be a senior manager tasked with managing a particular application area such as a security mechanism or ticket management.

In some examples, stakeholders are identified via manually updated lists of stakeholders. For instance, a manager of a feature or an entity may identify stakeholders at the feature's or the entity's inception. Alternatively, as others work on the feature or entity, they may self-identify themselves as stakeholders. In other examples, a stakeholder list may be determined by gathering names from an organizational chart (“org chart”) that identifies individuals within the organization and their roles and relationships. In yet other examples, a stakeholder list may be determined by gathering names from an email or chat list associated with the application feature or entity. Some examples involve a hybrid approach in which stakeholders are identified via a combination of manually updated lists, org charts, and email/chat lists.

The accuracy of these approaches may depend on how up-to-date the manually updated lists, org charts, and email/chat lists are kept by administrators, managers, programmers, and the stakeholders themselves. Given the size and scope of many application development projects and individual's ever-changing roles within such projects, identifying stakeholders via manually updated lists, org charts, and/or email and chat lists may incorrectly identify individuals who are not stakeholders of the given application feature or area or may identify outdated stakeholders who are no longer current stakeholders. In addition, these approaches may fail to identify the most relevant or current stakeholders.

Examples described herein may improve the identification of a stakeholder list for a segment of an application by scanning an audit trail associated with the segment of the application and identifying the stakeholder list based on the audit trail. In some examples described herein, metadata associated with the segment of the application may also be scanned and the stakeholder list may be identified based on the audit trail and the metadata. In some examples, scanning the audit trail may involve identifying a set of user actions and a time for each user action associated with the segment of the application. Scanning the metadata may involve identifying a set of views and a time associated with each view associated with the segment of the application. In such examples, the stakeholder list may be a function of the set of user actions and the set of views.

In some examples described herein, a processing resource of a device may execute instructions on a machine-readable storage medium to identify a stakeholder list associated with a segment of an application. The machine-readable storage medium may be encoded with instructions to receive a request to identify the stakeholder list associated with the segment of the application. The machine-readable storage medium may further comprise instructions to scan an audit trail associated with the segment of the application and based on the audit trail, the stakeholder list may be identified via a machine-learning technique.

In some examples described herein, a device comprising a processing resource and a machine-readable storage medium may identify a stakeholder list associated with a segment of an application. The machine-readable storage medium may be encoded with instructions to receive a request to identify the stakeholder list associated with the segment of the application. The machine-readable storage medium may further comprise instructions to scan an audit trail associated with the segment of the application and scan metadata associated with the segment of the application. In addition, the machine-readable storage medium may include instructions to identify the stakeholder list via a machine-learning technique based on the audit trail and the metadata.

In some such examples described herein, the instructions to scan the audit trail may further comprise instructions to identify a set of user actions associated with the segment of the application, identify a type of user action for each user action of the set of user actions, identify a time associated with each user action of the set of user actions, and index the audit trail based on the set of user actions, the type of user action, or the time. In some such examples described herein, the instructions to scan the metadata may further comprise instructions to identify a set of views associated with the segment of the application, identify a time associated with each view of the set of views, and index the metadata based on the set of views or the time. In some such examples, the instructions to identify the stakeholder list may further comprise instructions to assign a weight to each user action of the set of user actions based on the time and the type of user action, assign a weight to each view of the set of views based on the time, and determine an order of each stakeholder in the stakeholder list as a function of the assigned weight of each user action and the assigned weight of each view. In other such examples, the instructions to identify the stakeholder list may further comprise instructions to identify a role of each stakeholder in the stakeholder list based on the set of user actions and the set of views.

In some examples described herein, a method of identifying a stakeholder list associated with a segment of an application may comprise receiving a request to identify the stakeholder list associated with a segment of the application where the segment is a feature, an entity, or an area of the application. The method may also include scanning, by a processing resource, an audit trail associated with the segment of the application and scanning, by the processing resource, metadata associated with the segment of the application. Based on the audit trail and the metadata, the stakeholder list is identified by the processing resource and via a machine-learning technique. In examples described herein, a determination, action, etc., that is said to be “based on” a given condition may be based on that condition alone or based on that condition and other condition(s).

The examples described herein may utilize machine-learning techniques to improve the accuracy of stakeholder identification such that relevant stakeholders are identified with greater accuracy and regularity. The examples described herein may also utilize machine-learning techniques to more accurately identify a role of each stakeholder. By analyzing an audit trail associated with a segment of an application and metadata associated with a segment of an application, the examples described herein may provide substantial efficiencies, mitigate defects, and provide real world improvements to application development and management.

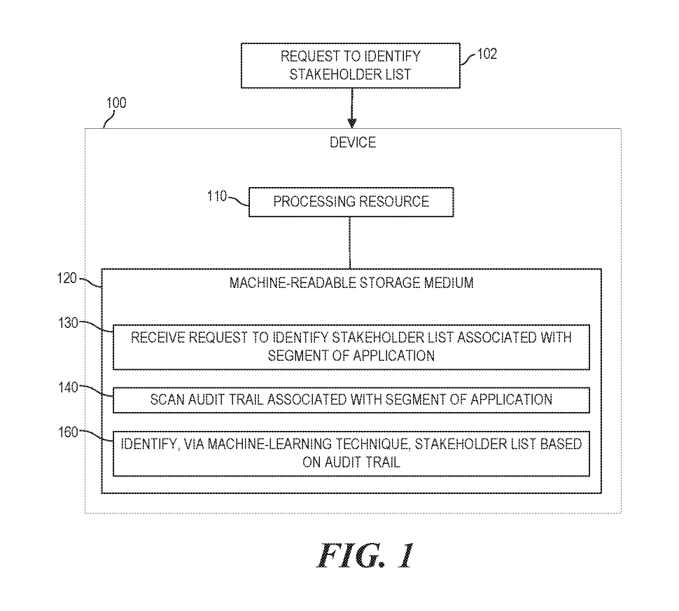

Referring now to the drawings, FIG. 1 is a block diagram of an example processing resource 110 and a machine-readable storage medium 120 comprising (e.g., encoded with) instructions 130, 140, and 160 executable by processing resource 110 to implement functionalities described herein in relation to FIG. 1. As shown, in the example of FIG. 1, device 100 includes processing resource 110 and a machine-readable storage medium 120 to identify a stakeholder list associated with a segment of an application. The functionalities described herein in relation to instructions 130, 140, 160, and any additional instructions described herein in relation to storage medium 120, are implemented at least in part in electronic circuitry (e.g., via any combination of hardware and programming to implement functionalities, as described below).

As used herein, a device may be a desktop computer, laptop (or notebook) computer, workstation, tablet computer, mobile phone, smart device, switch, router, server, blade enclosure, or any other processing device or equipment including a processor or processing resource.

In examples described herein, a processing resource may include, for example, one processor or multiple processors included in a single computing device or distributed across multiple devices. As used herein, a processor may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution instructions stored on a machine-readable storage medium, or a combination thereof.

Processing resource 110 may fetch, decode, and execute instructions stored on storage medium 120 to perform the functionalities described below in relation to instructions 130, 140, and 160. In other examples, the functionalities of any of the instructions of storage medium 120 may be implemented in the form of electronic circuitry, in the form of executable instructions encoded on a machine-readable storage medium, or a combination thereof. The storage medium may be located either in the device executing the machine-readable instructions, as shown in FIG. 1, or remote from but accessible to the device (e.g., via a computer network) for execution. In the example of FIG. 1, storage medium 120 may be implemented by one machine-readable storage medium, or multiple machine-readable storage media.

As used herein, a machine-readable storage medium may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

In the example of FIG. 1, instructions 130 receive a request to identify a stakeholder list 102. The request to identify a stakeholder list 102 is a request that is associated with a segment of an application. An application, as used herein, may refer to a computer program designed to perform a set of functions, tasks, activities, and operations. Applications may be designed for many different computing or networking environments, including, mobile computing devices, desktop configurations, laptops, and server configurations. In some examples, an application may be made up of application features, application entities, and/or application areas. An application feature is a distinct element of functionality that can provide a capability. An application entity is a functional component of an application and may be made up of multiple, related application features. An application area is a broad subject category of an application (e.g., filter mechanism, notification service, etc.) that may encompass multiple application entities and/or application features.

As used herein, a stakeholder may refer to an individual that is actively involved with a feature, entity, or area of an application and can influence the feature, entity, or area of the application. Some stakeholders may have a greater or lesser degree of involvement and influence than others. A stakeholder list refers to a list or a set of stakeholders.

In some examples, instructions 130 may receive the request to identify a stakeholder list from a user such as a functional architect, tester, developer, or other individual tasked with developing the segment of the application. For instance, a quality assurance technician tasked with testing a particular feature of an application may request a stakeholder list for the feature to discuss the feature with those individuals who may be most familiar with the feature. In other examples, instructions 130 may receive the request to identify a stakeholder list from another application.

Instructions 140 scan an audit trail associated with the segment of the application. An audit trail, as used herein, may refer to a record of actions related to a segment of the application. For instance, an audit trail may be generated at application feature's inception and may contain a record of each addition or change made to the feature. In some examples the audit trail may be stored in an audit database. The audit database may be located in central server or servers associated with the application. If the request to identify a stakeholder list 102 is associated with a particular feature of the application, instructions 140 may analyze the audit trail associated with that feature. If, however, the request to identify a stakeholder list is associated with an area of the application such the upgrade mechanism, instructions 140 may analyze each audit trail associated with features or entities related to the upgrade mechanism.

In the example of FIG. 1, instructions 160 identify, via a machine-learning technique, the stakeholder list based (at least in part) on the audit trail. As used herein, a machine-learning technique may refer to a learning model used by a computing device to detect patterns in data and adjust its model accordingly. In some examples, instructions 160 may use support vector machine (SVM) classification to determine a likelihood that an individual is a stakeholder. For instance, based (at least in part) on the audit trail, instructions 160 may determine an individual's actions, the frequency of those actions, the time spent, and how recently the actions were undertaken to determine whether an individual is a stakeholder or not. Frequent, lengthy actions taken recently may indicate a user is a stakeholder. On the other hand, infrequent actions or a history of actions that are no longer recent may indicate a user is not a stakeholder or was once a stakeholder, but is no longer a stakeholder.

In some examples, a training set may be used to develop a set of rules for use by the machine learning technique. In other examples, upon identifying a stakeholder or a stakeholder list, confirmation may be requested via an application programming interface (API) call. Based (at least in part) on the answer, the machine-learning technique may adjust its set of rules to improve accuracy.

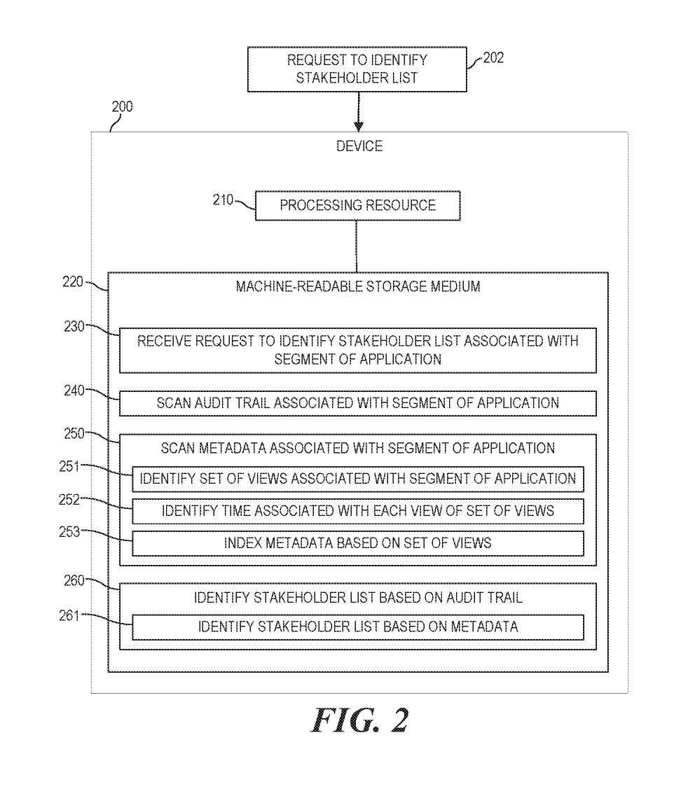

Instructions 130, 140, and 160 may be part of an installation package that, when installed, may be executed by processing resource 110 to implement the functionalities described above. In such examples, storage medium 120 may be a portable medium, such as a CD, DVD, or flash drive, or a memory maintained by a server from which the installation package can be downloaded and installed. In other examples, instructions 130, 140, and 160 may be part of an application, applications, or component(s) already installed on device 100 including processing resource 110. In such examples, the storage medium 120 may include memory such as a hard drive, solid state drive, or the like. In some examples, functionalities described herein in relation to FIG. 1 may be provided in combination with functionalities described herein in relation to any of FIGS. 2-6.

Further examples are described with reference to FIG. 2. FIG. 2 is a block diagram of an example processing resource 210 and a machine-readable storage medium 220 comprising (e.g., encoded with) instructions 230, 240, 250, 251, 252, 253, 260, and 261 executable by processing resource 210 to implement functionalities described herein in relation to FIG. 2. Device 200 includes processing resource 210 and a machine-readable storage medium 220 to identify a stakeholder list associated with a segment of an application. The storage medium may be located either in the device executing the machine-readable instructions, as shown in FIG. 2, or remote from but accessible to the device (e.g., via a computer network) for execution. The functionalities described herein in relation to instructions 230, 240, 250, 251, 252, 253, 260, 261, and any additional instructions described herein in relation to storage medium 220, are implemented at least in part in electronic circuitry (e.g., via any combination of hardware and programming to implement functionalities, as described below).

Instructions 230 receive a request to identify a stakeholder list 202 associated with a segment of the application, as described above in relation to instructions 130 and request 102 of FIG. 1. Instructions 240 scan an audit trail associated with the segment of the application, as described above in relation to instructions 140 of FIG. 1. Instructions 250 scan metadata associated with the segment of the application. As used herein, metadata may refer to data that provides information about other data. In some examples, each action taken by a user with respect to an application generates metadata. Instructions 250 may analyze the metadata associated with the requested segment of the application. Instructions 250 may, in some examples, further comprise instructions 251, 252, and 253.

Metadata associated with the segment of the application may include information relevant to the application segment that is not included in the audit trail. While an audit trail may record and log any changes made to the application segment, metadata may further capture any views, without changes, of the application segment by individuals. In some instances, the metadata may further capture a time associated with the view, including the length of the view. As depicted in FIG. 2, instructions 251 identify a set of views associated with the segment of the application. In that regard, instructions 251 may analyze the metadata associated with the requested segment to determine all views associated with the segment of the application, or a particular set of views associated with the segment of the application. The particular set of views that the metadata is analyzed for may depend on request 202.

Instructions 252 identify a time associated with each view of the identified set of views associated with the segment of the application. Identifying a time may involve determining a date and time that the view occurred along with a length of time of the view. Instructions 253 index the metadata based (at least in part) on the identified set of views. Indexing, as used herein, refers to a systematic sorting to improve searching. Instructions 253 sort the metadata based (at least in part) on the set of views so that a stakeholder may be more easily identified from the information. Sorting the metadata based (at least in part) on the set of views may also involve sorting the metadata by a time of each view. In some examples, instructions 253 may store the index in an index table, an index database, or other index data structure.

Analyzing metadata to capture a set of views may be useful in determining a stakeholder because many users, for instance entity or project managers, may view various features or entities without making any associated changes. These views may be significant in identifying higher level stakeholders, though they may not be captured in an audit log.

Instructions 260 identify, via a machine-learning technique, a stakeholder list based (at least in part) on an audit trail, as discussed above in relation to instructions 160 of FIG. 1. In the example of FIG. 2, instructions 260 further comprise instructions 261 to identify the stakeholder list also based (at least in part) on the metadata. Instructions 261 may analyze the indexed metadata to determine an individual's views, the frequency of those views, the time and length of each view, and how recently the view occurred to determine whether an individual is a stakeholder or not. Frequent, recent views may indicate a user is a stakeholder. On the other hand, infrequent views or a history of views that are no longer recent may indicate a user is not a stakeholder or was once a stakeholder, but is no longer a stakeholder.

Instructions 230, 240, 250, 251, 252, 253, 260, and 261 may be part of an installation package that, when installed, may be executed by processing resource 210 to implement the functionalities described above. In such examples, storage medium 220 may be a portable medium, such as a CD, DVD, or flash drive, or a memory maintained by a server from which the installation package can be downloaded and installed. In other examples, instructions 230, 240, 250, 251, 252, 253, 260, and 261 may be part of an application, applications, or component(s) already installed on device 200 including processing resource 210. In such examples, the storage medium 220 may include memory such as a hard drive, solid state drive, or the like. In some examples, functionalities described herein in relation to FIG. 2 may be provided in combination with functionalities described herein in relation to any of FIGS. 1 and 3-6.

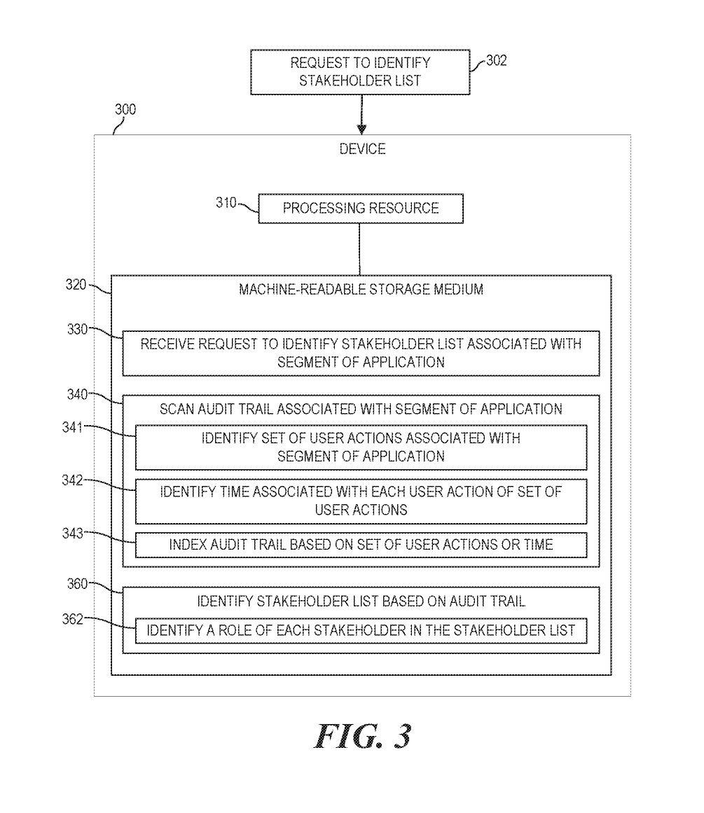

Additional examples are described in relation to FIG. 3. FIG. 3 is a block diagram of an example processing resource 310 and a machine-readable storage medium 320 comprising (e.g., encoded with) instructions 330, 340, 341, 342, 343, 360, and 362 executable by processing resource 310 to implement functionalities described herein in relation to FIG. 3. Device 300 includes processing resource 210 and a machine-readable storage medium 220 to identify a stakeholder list associated with a segment of an application. The storage medium may be located either in the device executing the machine-readable instructions, as shown in FIG. 1, or remote from but accessible to the device (e.g., via a computer network) for execution. The functionalities described herein in relation to instructions 330, 340, 341, 342, 343, 360, 362, and any additional instructions described herein in relation to storage medium 320 are implemented at least in part in electronic circuitry (e.g., via any combination of hardware and programming to implement functionalities, as described below).

Instructions 330 receive a request to identify a stakeholder list 302 associated with a segment of the application, as described above in relation to instructions 130 and request 102 of FIG. 1. Instructions 340 scan an audit trail associated with the segment of the application, as described above in relation to instructions 140 of FIG. 1. Instructions 340 may, in some examples, further comprise instructions 341, 342, and 343.

The audit trail may include a record or log of actions taken by individuals to change an application feature or entity. Instructions 341 identify a set of user actions associated with the segment of the application. In that regard, instructions 341 may analyze the audit trail associated with the requested segment to determine all recorded user actions associated with the segment of the application, or a particular set of recorded user actions associated with the segment of the application. The particular set of user actions that the audit trail is analyzed for may depend on request 302.

Instructions 342 identify a time associated with each user action of the identified set of user actions associated with the segment of the application. Identifying a time may involve determining a date and time that the user action occurred. In some examples, it may also involve determining the length of time of the user action. Instructions 343 index the audit trail based (at least in part) on the identified set of user actions or the time. For instance, instructions 343 sort the metadata based (at least in part) on the set of user actions or based (at least in part) on the time associated with each user action of the set of user actions so that a stakeholder may be more easily identified from the information. In some examples, instructions 343 may store the index in an index table, an index database, or other index data structure.

Instructions 360 identify, via a machine-learning technique, a stakeholder list based (at least in part) on an audit trail, as discussed above in relation to instructions 160 of FIG. 1. In some examples, the machine-learning technique may identify the stakeholder list as a function of the set of user actions and the time associated with each user action of the set of user actions. Based (at least in part) on an individual's actions, the time of their actions, and/or the frequency of their actions, the machine-learning technique may determine a likelihood that an individual is a stakeholder.

In the example of FIG. 3, instructions 360 further comprise instructions 362 to identify a role of each stakeholder in the stakeholder list. Instructions 362 may use a machine-learning technique to determine a likelihood of a stakeholder having a particular role. In one example, instructions 360 may use a radial basis function (RBF) kernel in SVM classification. To identify the role of each stakeholder associated with a particular application feature, F*R SVM classifiers may be created where F represents the number of features and R represents the number or roles. Each SVM classifier outputs the likelihood that a specific stakeholder has a particular role for that feature. The SVM classifier with the maximal likelihood determines the role of the stakeholder. For example, a stakeholder that spends 80% of her time in an application feature creating a user story and 20% of her time in the application feature creating the feature may be identified via the SVM classifiers to have the role of product owner. In another example, a stakeholder that spends 75% of his time in an application feature creating a test and 25% of his time in the application feature reading the user story may be identified via the SVM classifiers to be a quality assurance technician.

Instructions 330, 340, 341, 342, 343, 360, and 362 may be part of an installation package that, when installed, may be executed by processing resource 310 to implement the functionalities described above. In such examples, storage medium 320 may be a portable medium, such as a CD, DVD, or flash drive, or a memory maintained by a server from which the installation package can be downloaded and installed. In other examples, instructions 330, 340, 341, 342, 343, 360, and 362 may be part of an application, applications, or component(s) already installed on device 300 including processing resource 310. In such examples, the storage medium 320 may include memory such as a hard drive, solid state drive, or the like. In some examples, functionalities described herein in relation to FIG. 3 may be provided in combination with functionalities described herein in relation to any of FIGS. 1-2 and 4-6.

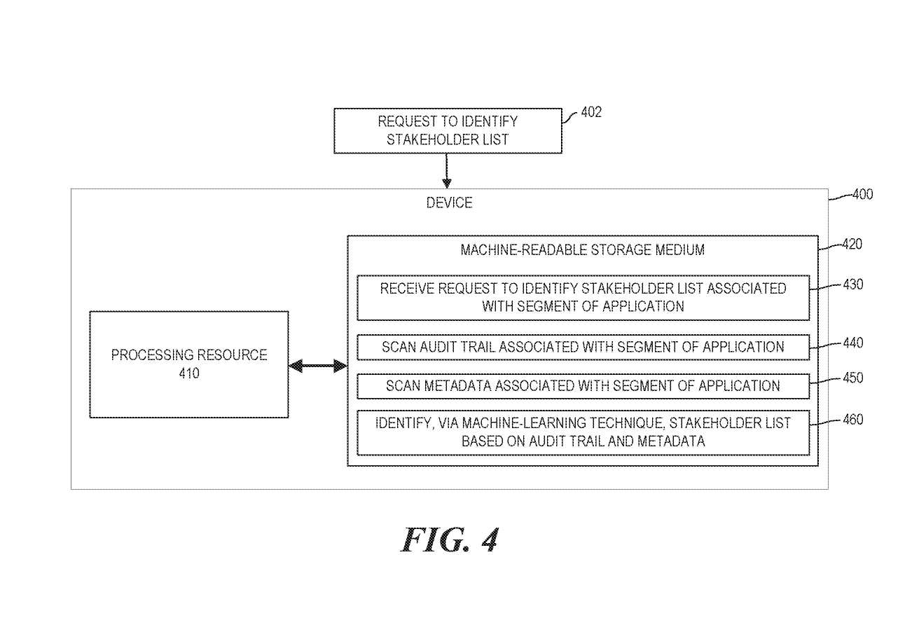

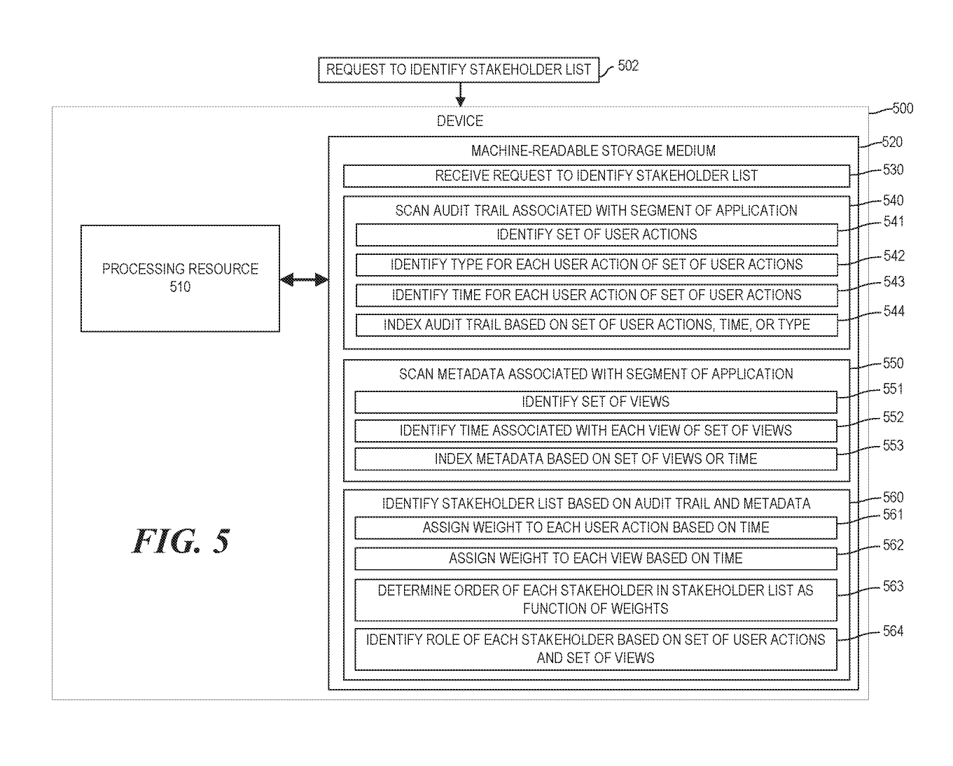

Further examples are described herein in regards to FIGS. 4 and 5. FIG. 4 is a block diagram of an example device 400 comprising a processing resource 410 and a machine-readable storage medium 420 having instructions executable by the processing resource 410 to identify a stakeholder list associated with a segment of an application. Machine-readable storage medium 420 comprises (e.g., is encoded with) instructions 430, 440, 450, and 460 executable by processing resource 410 to implement functionalities described herein in relation to FIG. 4. The functionalities described herein in relation to instructions 430, 440, 450, 460, and any additional instructions described herein in relation to storage medium 420, are implemented at least in part in electronic circuitry (e.g., via any combination of hardware and programming to implement functionalities, as described below).

Instructions 430 receive a request to identify a stakeholder list 402 associated with a segment of the application, as described above in relation to instructions 130 and request 102 of FIG. 1. A segment of the application may refer to a feature, an entity, or an area of the application. Instructions 440 scan an audit trail associated with the segment of the application, as described above in relation to instructions 140 of FIG. 1. Instructions 450 scan metadata associated with the segment of the application, as described above in relation to instructions 250 of FIG. 2. Instructions 460 identify, via a machine-learning technique, the stakeholder list based (at least in part) on the audit trail and metadata, as described above in relation to instructions 160 of FIG. 1 and instructions 261 of FIG. 2.

Instructions 430, 440, 450, and 460 may be part of an installation package that, when installed, may be executed by processing resource 410 to implement the functionalities described above. In such examples, storage medium 420 may be a portable medium, such as a CD, DVD, or flash drive, or a memory maintained by a server from which the installation package can be downloaded and installed. In other examples, instructions 430, 440, 450, and 460 may be part of an application, applications, or component(s) already installed on device 400 including processing resource 410. In such examples, the storage medium 420 may include memory such as a hard drive, solid state drive, or the like. In some examples, functionalities described herein in relation to FIG. 4 may be provided in combination with functionalities described herein in relation to any of FIGS. 1-3 and 5-6.

FIG. 5 is a block diagram of an example device 500 comprising a processing resource 510 and a machine-readable storage medium 520 having instructions executable by the processing resource 510 to identify a stakeholder list associated with a segment of an application. Machine-readable storage medium 520 comprises (e.g., is encoded with) instructions 530, 540, 541, 542, 543, 544, 550, 551, 552, 553, 560, 561, 562, 563, and 564 executable by processing resource 510 to implement functionalities described herein in relation to FIG. 5. The functionalities described herein in relation to instructions 30, 540, 541, 542, 543, 544, 550, 551, 552, 553, 560, 561, 562, 563, 564, and any additional instructions described herein in relation to storage medium 520, are implemented at least in part in electronic circuitry (e.g., via any combination of hardware and programming to implement functionalities, as described below).

Instructions 530 receive a request to identify a stakeholder list 402 associated with a segment of the application, as described above in relation to instructions 130 and request 102 of FIG. 1. Instructions 540 scan an audit trail associated with the segment of the application, as described above in relation to instructions 140 of FIG. 1. Instructions 540 may, in some examples, further comprise instructions 541, 542, and 543.

Instructions 541 identify a set of user actions associated with the segment of the application, as described above in relation to instructions 341 of FIG. 3. Instructions 542 identify a type of each user action of the set of identified user actions. In some examples, the audit trail may be analyzed to determine whether user actions occurred and what type of user action occurred. For instance, the audit trail may be analyzed to determine whether a particular action created the feature, created the user story, created a test, executed a test, created a defect, and the like. Each of these types of user actions may be relevant to determining whether a particular user is a stakeholder or what a particular user's role may be. Instructions 543 identify a time associated with each user action of the identified set of user actions associated with the segment of the application, as describe above in relation to instructions 342 of FIG. 3. Instructions 544 may index the audit trail based (at least in part) on the identified set of user actions or the time, as described above in relation to instructions 343 of FIG. 3. Instructions 544 may also index the audit trail based (at least in part) on the type of user action. Sorting the metadata based (at least in part) on the type of user action associated with each user action of the set of user actions may allow stakeholders and their roles to be more easily identified from the information. In some examples, instructions 544 may store the index in an index table, an index database, or other index data structure.

Instructions 550 scan metadata associated with the segment of the application, as described above in relation to instructions 250 of FIG. 2. Instructions 550 may, in some examples, further comprise instructions 551, 552, and 553. Instructions 551 identify a set of views associated with the segment of the application, as described above in relation to instructions 251 of FIG. 2. Instructions 552 identify a time associated with each view of the identified set of views associated with the segment of the application, as described above in relation to instructions 252 of FIG. 2. Instructions 553 index the metadata based (at least in part) on the identified set of views, as described above in relation to instructions 253 of FIG. 2. Instructions 553 may also sort the metadata based (at least in part) on the time of each view of the set of views.

Instructions 560 identify, via a machine-learning technique, the stakeholder list based (at least in part) on the audit trail and metadata, as described above in relation to instructions 160 of FIG. 1 and instructions 261 of FIG. 2. Instructions 560 may, in some examples, further comprise instructions 561, 562, 563, and 564.

In some examples, the machine-learning technique may use a weighting mechanism to determine which users may be stakeholders and which stakeholders may have a greater stake in or influence on the application feature, area, or segment. In that regard, instructions 561 assign a weight to each user action based (at least in part) on the time of the user action. For instance, the machine-learning technique may assign a greater weight to actions more recent in time and a lesser weight to actions less recent in time. The machine-learning technique may also assign a greater weight to certain types of actions or for actions lasting different lengths of time. As an example, 10 minutes spent reading a user story of an application feature may be weighted more heavily than 2 minutes spent reading the user story of the application feature.

Likewise, instructions 562 assign a weight to each view of the set of views based (at least in part) on the time of the view. In some examples, the machine-learning technique may assign a greater weight to a view that is more recent in time and a lesser weight to a view that is less recent in time. In other examples, the machine-learning technique may assign greater weights for longer views and lesser weights for shorter views.

In some examples, the stakeholders within a stakeholder list may be identified as a function of the assigned weights. As an example, each individual's user actions with respect to a requested segment of an application may be weighted based (at least in part) on the action, the time, and/or the length of time of the action. Similarly, each individual's views with respect to the requested segment of the application may be weighted based (at least in part) on the time and/or the length of the view. These may then be summed to determine the likelihood that the individual is a stakeholder.

Instructions 563 may additionally determine an order of each stakeholder in the stakeholder list as a function of the assigned weight of each user action and the assigned weight of each view. The order of the stakeholders may identify those stakeholders having a greater stake in, greater influence on, or greater knowledge about the requested segment of the application. In some examples, each individual's user actions and views associated with the requested segment of the application may be weighted and summed. The individual with the largest sum would be the stakeholder with the greatest likelihood of having the greatest stake in, the greatest influence on, or the most knowledge about the requested segment of the application. The individual having the second largest sum would be the stakeholder with the greatest likelihood of having the second greatest stake in, the second greatest influence on, or the second most knowledge about the requested segment of the application, and so on.

Instructions 564 identify a role of each stakeholder based (at least in part) on the set of user actions and the set of views, as described above in relation to instructions 362 of FIG. 3. Instructions 564 may use a machine-learning technique to determine a likelihood of a stakeholder having a particular role. In one example, the machine-learning technique may apply a set of dynamic rules that categorize certain actions or views as descriptive of a certain role. For instance, a stakeholder that spends 40% of her time in an application feature updating the user story and 60% of her time in the application feature updating to correct a defect may be identified by the machine-learning technique as a developer. On the other hand, a stakeholder that spends a short amount of time viewing several application features may be identified by machine-learning technique as a manager.

In some examples, the audit trail and/or the metadata may be scanned and indexed prior to receiving a request to identify a list of stakeholders associated with a segment of an application. In such examples, the audit trail and metadata may be scanned and indexed at start-up or login. In other such examples, the audit trail and metadata may be periodically scanned and indexed. The stakeholder list may be identified via a machine-learning technique by accessing an index of the audit trail and an index of the metadata.

Instructions 530, 540, 541, 542, 543, 544, 550, 551, 552, 553, 560, 561, 562, 563, and 564 may be part of an installation package that, when installed, may be executed by processing resource 510 to implement the functionalities described above. In such examples, storage medium 520 may be a portable medium, such as a CD, DVD, or flash drive, or a memory maintained by a server from which the installation package can be downloaded and installed. In other examples, instructions 530, 540, 541, 542, 543, 544, 550, 551, 552, 553, 560, 561, 562, 563, and 564 may be part of an application, applications, or component(s) already installed on device 500 including processing resource 510. In such examples, the storage medium 520 may include memory such as a hard drive, solid state drive, or the like. In some examples, functionalities described herein in relation to FIG. 5 may be provided in combination with functionalities described herein in relation to any of FIGS. 1-4 and 6.

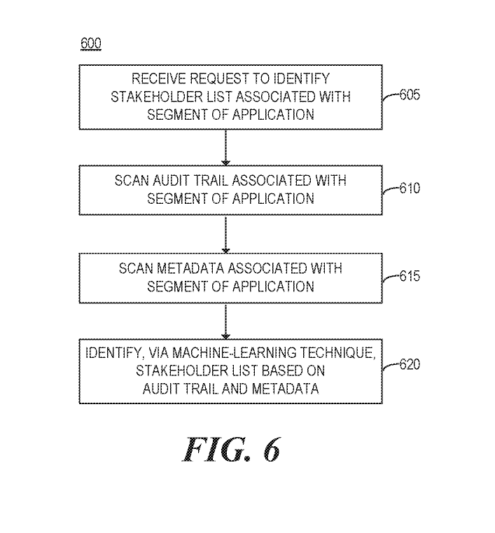

FIG. 6 is a flowchart of an example method 600 of identifying a stakeholder associated with a segment of an application. Execution of method 600 is described below with reference to various features of the examples described above (e.g., device 100 of FIG. 1, device 400 of FIG. 4, etc.). Implementation of method 600 is not limited to such examples, however.

In the example of FIG. 6, method 600 may be a method of any of devices 100, 200, 300, 400, and 500 of FIGS. 1-6, respectively. At 605, a request to identify a stakeholder list associated with a segment of the application may be received. This receipt may be performed as described above in relation to instructions 130 of FIG. 1. The segment of the application is a feature, an entity, or an area of the application.

At 610, a processing resource may scan an audit trail associated with the segment of the application, as described above in relation to instructions 140 of FIG. 1. In some examples, scanning the audit trail may further comprise any or all of identifying a set of user actions associated with the segment of the application, identifying a type of user action for each user action of the set of user actions, identifying a time associated with each user action of the set of user actions, and/or indexing the audit trail based (at least in part) on the set of user actions, the type of user action, or the time. These actions may be performed as described above in relation to instructions 541, 542, 543, and 544, respectively, of FIG. 5.

At 615, a processing resource may scan metadata associated with the segment of the application, as described above in relation to instructions 250 of FIG. 2. In some examples, scanning the metadata may further comprise any or all of identifying a set of views associated with the segment of the application, identifying a time associated with each view of the set of views, and/or indexing the metadata based (at least in part) on the set of views or the time. These actions may be performed as described above in relation to instructions 551, 552, and 553, respectively, of FIG. 5.

At 620, a stakeholder list may be identified via a machine-learning technique based (at least in part) on the audit trail and the metadata, as described above in relation to instructions 560 of FIG. 5. In some examples, identifying the stakeholder list may further comprise any or all of assigning a weight to each user action of the set of user actions based (at least in part) on time, assigning a weight to each view of the set of views based (at least in part) on time, determining an order of each stakeholder in the stakeholder list as a function of the assigned weight of each user action and the assigned weight of each view, and identifying a role of each stakeholder in the stakeholder list based (at least in part) on the set of user actions and the set of views. These actions may be performed as described above in relation to instructions 561, 562, 563, and 564, respectively, of FIG. 5.

In some examples, the machine-learning technique may determine a likelihood that a stakeholder has a particular role based (at least in part) on a set of dynamic rules that categorize certain actions or views as descriptive of a certain role. Based (at least in part) on a determination that a stakeholder has a maximal likelihood of having a particular role, that role is identified as the role of the stakeholder. In some examples, the stakeholder may be requested to confirm or deny the role in relation to the segment of the application. Based (at least in part) on feedback as to the correctness of the identified role, the machine-learning technique may adjust its set of rules associated with the role to improve accuracy.

Although the flowchart of FIG. 6 shows a specific order of performance of certain functionalities, method 600 may not be limited to that order. For example, the functionalities shown in succession in the flowchart may be performed in a different order, may be executed concurrently or with partial concurrence, or a combination thereof. In some examples, functionalities described herein in relation to FIG. 6 may be provided in combination with functionalities described herein in relation to any of FIGS. 1-5.

What is claimed is:

1. A machine-readable storage medium encoded with instructions executable by a processing resource of a device to identify a stakeholder list associated with a segment of an application, the machine-readable storage medium comprising instructions to:
receive a request to identify the stakeholder list associated with the segment of the application;
scan an audit trail associated with the segment of the application; and
identify, via a machine-learning technique, the stakeholder list based on the audit trail.

2. The machine-readable storage medium of claim 1, wherein the machine-readable storage medium further comprises instructions to:
scan metadata associated with the segment of the application.

3. The machine-readable storage medium of claim 2, wherein the instructions to scan the metadata further comprise instructions to:
identify a set of views associated with the segment of the application;
identify a time associated with each view of the set of views; and
index the metadata based on the set of views.

4. The machine-readable storage medium of claim 2, wherein the instructions to identify the stakeholder list further comprise instructions to:
identify the stakeholder list based on the metadata.

5. The machine-readable storage medium of claim 1, wherein the instructions to scan the audit trail further comprise instructions to:
identify a set of user actions associated with the segment of the application;
identify a time associated with each user action of the set of user actions; and
index the audit trail based on the set of user actions or the time.

6. The machine-readable storage medium of claim 5, wherein the machine-learning technique identifies the stakeholder list as a function of the set of user actions and the time associated with each user action of the set of user actions.

7. The machine-readable storage medium of claim 1, wherein the instructions to identify the stakeholder list further comprise instructions to:
identify a role of each stakeholder in the stakeholder list.

8. The machine-readable storage medium of claim 1, wherein the segment of the application is a feature, an entity, or an area of the application.

9. A device to identify a stakeholder list associated with a segment of an application comprising:
a processing resource; and
a machine-readable storage medium encoded with instructions executable by the processing resource, the machine-readable storage medium comprising instructions to:
receive a request to identify the stakeholder list associated with the segment of the application;
scan an audit trail associated with the segment of the application;
scan metadata associated with the segment of the application; and
identify, via a machine-learning technique, the stakeholder list based on the audit trail and the metadata.

10. The computing device of claim 9, wherein the instructions to scan the audit trail further comprise instructions to:
identify a set of user actions associated with the segment of the application;
identify a type of user action for each user action of the set of user actions;
identify a time associated with each user action of the set of user actions; and
index the audit trail based on the set of user actions, the type of user action, or the time.

11. The computing device of claim 10, wherein the instructions to scan the metadata further comprise instructions to:
identify a set of views associated with the segment of the application;
identify a time associated with each view of the set of views; and
index the metadata based on the set of views or the time.

12. The computing device of claim 11, wherein the instructions to identify the stakeholder list comprise instructions to:
assign a weight to each user action of the set of user actions based on the time and the type of user action;
assign a weight to each view of the set of views based on the time; and
determine an order of each stakeholder in the stakeholder list as a function of the assigned weight of each user action and the assigned weight of each view.

13. The computing device of claim 11, wherein the instructions to identify the stakeholder list further comprise instructions to:
identify a role of each stakeholder in the stakeholder list based on the set of user actions and the set of views.

14. The computing device of claim 9, wherein the segment of the application is a feature, an entity, or an area of the application.

15. A method of identifying a stakeholder list associated with a segment of an application, the method comprising:
receiving a request to identify the stakeholder list associated with the segment of the application, wherein the segment is a feature, an entity, or an area of the application;
scanning, by a processing resource, an audit trail associated with the segment of the application;
scanning, by the processing resource, metadata associated with the segment of the application; and
identifying, by the processing resource and via a machine-learning technique, the stakeholder list based on the audit trail and the metadata.

16. The method of claim 15, wherein scanning the audit trail further comprises:
identifying a set of user actions associated with the segment of the application;
identifying a type of user action for each user action of the set of user actions;
identifying a time associated with each user action of the set of user actions; and
indexing the audit trail based on the set of user actions, the type, or the time.

17. The method of claim 16, wherein scanning the metadata further comprises:
identifying a set of views associated with the segment of the application;
identifying a time associated with each view of the set of views; and
indexing the metadata based on the set of views.

18. The method of claim 17, wherein identifying the stakeholder list comprises:
assigning a weight to each user action of the set of user actions based on the time of the user action;
assigning a weight to each view of the set of views based on the time of the view; and
determining an order of each stakeholder in the stakeholder list as a function of the assigned weight of each user action and the assigned weight of each view.

19. The method of claim 17, wherein identifying the stakeholder list further comprises identifying a role of each stakeholder in the stakeholder list based on the set of user actions and the set of views.

20. The method of claim 19, wherein the machine-learning technique determines a likelihood that a stakeholder has a role based on a set of rules associated with the role, identifies as the role of the stakeholder the role that has a maximal likelihood, and adjusts the set of rules associated with the role in response to feedback as to the correctness of the role.
